(19) United States
(12) Patent Application Publication
(10) Pub. No.: US 2026/0302280 A1
(43) Pub. Date: Oct. 1, 2026

(54) STACK PLATE, STACK PLATE DEVICE AND HUMIDIFIER

(71) Applicant: MANN+HUMMEL GmbH, Ludwigsburg (DE)

(72) Inventor: Alexander KORN, Güglingen (DE)

(21) Appl. No.: 19/696,740

(22) Filed: Jun. 3, 2026

Related U.S. Application Data
(63) Continuation of application No. 18/475,811, filed on Sep. 27, 2023, now Pat. No. 12,658,457.

(30) Foreign Application Priority Data
Dec. 1, 2022 (EP) 22210894

(51) Int. Cl. H01M 8/04119

(52) U.S. Cl. CPC H01M 8/04149

(57) ABSTRACT

A stack plate of a stack plate device of a humidifier includes inlay parts extending along two opposing front and/or two opposing longitudinal ends of the stack plate, a semi-permeable layer disposed on and supported by the inlay parts, and a frame disposed on the semi-permeable layer supported by the inlay parts, the frame circumferentially enclosing a through-opening in the stack plate. A remaining portion of the semi-permeable layer covers the through-opening. An outer circumferential section of the semi-permeable layer and the inlay parts are embedded within an over-molded portion of the frame. Opposing front ends of the frame define inflow and outflow regions, respectively, on a first side of the frame for a second fluid, and opposing longitudinal ends of the frame define inflow and outflow regions, respectively, on a second side of the frame for a first fluid.

### CROSS-REFERENCE TO RELATED APPLICATIONS

This application is a continuation of US application No. 18/475,811 having a filing date of September 27, 2023, which claims the benefit of European Application No. 22 210 894.6 filed on December 1, 2022, the entire contents of which are incorporated herein by reference to the fullest extent permissible.

### BACKGROUND

The invention relates to a stack plate for a stack plate device of a humidifier, for example a humidifier for a fuel cell system, a stack plate device for a humidifier, as well as a humidifier for a fuel cell system.

US 2017/0279138 AA discloses a humidifier comprising a hollow shell and a humidifier core. The humidifier core includes a transfer sheet, a plurality of first channels, and a plurality of second channels. The transfer sheet comprises a permeable material having a plurality of sections and a plurality of layers of spacing materials. The plurality of first channels are configured to allow air flow in a first direction and to prevent airflow in a second direction that is different from the first direction. The plurality of second channels are configured to allow air flow in the second direction and to prevent airflow in the first direction. The humidifier comprises a stack of alternating first channels and second channels, and the first channels are configured to transfer liquid from air flowing in at least one of the first channels to air flowing in at least one of the second channels. The humidifier is suitable for use in fuel cell stack.

It is an object of the invention to provide a cost-efficient stack plate for a stack plate device of a humidifier, for example a humidifier for a fuel cell system.

Another object is to provide a cost-efficient stack plate device for a humidifier, for example for a fuel cell system.

Another object is to provide a cost-efficient humidifier for a fuel cell system.

According to an aspect of the invention the object is achieved by a stack plate for a stack plate device of a humidifier, for example a humidifier for a fuel cell system, the stack plate comprising a circumferential frame which encloses a through-opening in the stack plate, wherein a semi-permeable layer completely covers the through-opening, the semi-permeable layer being supported by at least one inlay part at least at two opposing front ends and/or at two opposing longitudinal ends, wherein an outer circumference of the semi-permeable layer together with the at least one inlay part are embedded in the frame, wherein opposing front ends of the frame define inflow and outflow regions, respectively, on a first side of the frame for a second fluid and opposing longitudinal ends of the frame define inflow and outflow regions, respectively, on a second side of the frame for a first fluid.

According to a further aspect of the invention, the further object is achieved by a stack plate device for a humidifier, for example for a fuel cell system, having a plurality of stack plates, the stack plates being stacked one atop of each other alternately in a stacking direction with first sides of adjacent stack plates facing first sides and second sides of adjacent stack plates facing second sides, and each stack plate comprising a peripheral frame which encloses a through-opening in the respective stack plate, wherein at least first and second groups of flow channels are formed in the stack plate device for fluid flow transversely to one another on both sides of the stack plates and being separated by semi-permeable layers, for example moisture-permeable layers, wherein three of the alternatingly successive stack plates each form two of the flow channels, which are formed such that flow can pass through them transversely to one another.

According to a further aspect of the invention, the further object is achieved by a humidifier for a fuel cell system, comprising a housing which has at least one inlet for a first fluid, in particular an exhaust gas of the fuel cell system, an inlet for a second fluid, in particular a supply air of the fuel cell system, an outlet for the first fluid and an outlet for the second fluid, further comprising a stack plate device, in which a plurality of stack plates is arranged, the stack plates being stacked one atop of each other alternately in a stacking direction, with first sides of adjacent stack plates facing first sides and second sides of adjacent stack plates facing second sides, wherein three each of the alternately successive stack plates form a first and a second group of flow channels formed transversely to each other for flow of the first or second fluid therethrough, wherein the first group of flow channels are arranged between the inlet and the outlet for the first fluid and the second group of flow channels are arranged between the inlet and the outlet for the second fluid.

Embodiments are described in the following description and the accompanying drawings.

According to an aspect of the invention, a stack plate for a stack plate device of a humidifier, for example a humidifier for a fuel cell system, is proposed, the stack plate comprising a circumferential frame which encloses a through-opening in the stack plate, wherein a semi-permeable layer completely covers the through-opening, the semi-permeable layer being supported by at least one inlay part at least at two opposing front ends and/or at two opposing longitudinal ends. An outer circumference of the semi-permeable layer together with the at least one inlay part are embedded in the frame. Opposing front ends of the frame define inflow and outflow regions, respectively, on a first side of the frame for a second fluid and opposing longitudinal ends of the frame define inflow and outflow regions, respectively, on a second side of the frame for a first fluid.

The through-opening may be a single hole in the frame or may be a region with multiple breakthroughs.

The proposed stack plate serves for the construction of a stack plate device, which is suitable for a flat membrane humidifier. The fluid flow channels (exhaust gas and supply air channel) are formed by means of two stack plates and are used for the flow of moisture-laden exhaust gas, for example from a fuel cell, and dry supply air in the neighboring flow channel. The supply air may be humidified by moisture from the exhaust gas through the semi-permeable layer.

The semi-permeable layer thus separates the exhaust gas flow channel from the supply air flow channel. The semi-permeable layer may be designed, for example, as a PFSA (perfluorosulfonic acid) membrane. Such membranes are also commonly used as proton exchange membranes. The membrane is airtight but permeable to moisture. The semi-permeable layer can be over-molded, for example together with inlay parts which support the semi-permeable layer, and thus, serve as a stable frame of the stack plate. The stack plates are assembled by stacking the frames of the stack plates over each other, for example in a way where first sides of adjacent stack plates face first sides and second sides of adjacent stack plates face second sides.

The stack plates comprise the at least one inlay part as a carrier, the semi-permeable layer and an overmold, e.g., from silicone. The inlay part may be from plastics, e.g., PPS (polyphenylene sulfide), with a small thickness of, e.g., about 0.3 mm, or from stainless steel, e.g., for a stable support. The silicone over-molding seals the semi-permeable layer and also seals the gas flow channels against each other. It is possible to mount specific grid-like support elements, e.g., with ribs to the stack plate which support the semi-permeable layer and also regulate the fluid flow for optimized mass transfer between the fluid channels through the semi-permeable layer. Geometric parameters such as height, lattice angle, spacing and the like of struts of the support elements may vary. In addition, a grid may be inserted in the supply air channel to further optimize the mass transfer through the semi-permeable layer. For cost optimization, the grid may be minimized or, if desired, completely omitted.

According to an embodiment of the stack plate, the frame may comprise an over-molded portion of the outer circumference of the semi-permeable layer together with the at least one inlay part. The silicone over-molding seals the semi-permeable layer and also seals the gas flow channels to each other. The inlay parts stabilize the semi-permeable layer as well as the overmold. The overmold itself forms a stable frame of the stack plate. The inlay part embedded in the overmold acts as a mechanical stabilizer for the frame of the stack plate.

According to an embodiment of the stack plate, the longitudinal ends of the frame may have a first connecting region on the first side of the frame, for example with a first sealing, for being connected to the first side of the frame of a stack plate adjacent in the stack plate device when being alternatingly stacked for intended use, wherein the front ends of the frame have second connecting region on the second side of the frame, for example with a second sealing, for being connected to the second side of the frame of a stack plate adjacent in the stack plate device when being alternatingly stacked for intended use. Thus, the stack plates may advantageously form the fluid flow channels when stacked alternatingly one after the other in a stacking direction for building the stack plate device.

According to an embodiment of the stack plate, flow guiding elements may be arranged at the inflow and/or outflow regions, for example at the inflow and/or outflow regions for the second fluid. By this way steady flow conditions may be established for optimized humidity transfer from the exhaust gas to the supply air.

According to an embodiment of the stack plate, the stack plate may further comprise a grid-like support element on the first side and/or the second side of the frame. The grid-like support elements with ribs may be arranged on the stack plate and may support the semi-permeable layer and also regulate the fluid flow for optimized mass transfer through the semi-permeable layer. Height, angle and spacing of struts of the grid-like support element may vary if necessary. The grid-like support element may be made from plastics, e.g., PPS, or from stainless steel, e.g., for a stable support. The grid-like support element can be attached to the frame of the stack plate in a shape adapted to the frame.

According to an embodiment of the stack plate, the at least one inlay part may comprise two inlay stripes being integrated into the frame at each of the opposing front ends of the frame or at each of the longitudinal ends of the frame, for example being over-molded at the front ends of the frame or at the longitudinal ends of the frame. Thus, the semi-permeable layer may advantageously be supported and stabilized against bending by the inlay stripes on both front ends in order to have stable support for the connection regions when the adjacent stack plates are stacked together. The over-molded frame may be used as a stable seal.

According to an embodiment of the stack plate, the at least one inlay part may comprise two first inlay stripes being integrated into the frame at each of the front ends of the frame and two second inlay stripes at each of the longitudinal ends of the frame, wherein the semi-permeable layer may be inserted between the first two inlay stripes and the second two inlay stripes. The outer circumference of the semi-permeable layer together with the first two inlay stripes and the second two inlay stripes may be over-molded to form the frame. In this further embodiment the semi-permeable layer is supported by additional inlay stripes on the longitudinal sides, thus forming a frame on all four sides for being over-molded. By this way after over-molding the frame exhibits enhanced strength and stability.

According to an embodiment of the stack plate, the at least one inlay part may comprise a plate supporting the semi-permeable layer, for example wherein the plate is configured as a grid-like support element. This embodiment delivers a stable support for the semi-permeable layer over the whole opening of the stack plate and additionally may be provided with ribs or struts for optimized transfer of the humidity from the exhaust gas to the supply air.

According to an embodiment of the stack plate, the plate may be configured with ribs, for example with L- and/or U-shaped ribs, aligned in an oblique manner to a flow direction of the first and/or second fluid. Thus, the grid-like support element may additionally be provided with L-shaped and/or U-shaped ribs for optimized transfer of the humidity from the exhaust gas to the supply air. By this way, the fluid flow may be effected in a desirable way for humidity transfer through the semi-permeable layer.

According to a further aspect of the invention, a stack plate device for a humidifier, for example for a fuel cell system, is proposed, comprising a plurality of stack plates, the stack plates being stacked one atop of each other alternately in a stacking direction with first sides of adjacent stack plates facing first sides and second sides of adjacent stack plates facing second sides and each stack plate comprising a peripheral frame which encloses a through-opening in the stack plate. At least first and second groups of flow channels are formed in the stack plate device, for fluid flow transversely to one another on the sides of the stack plates and being separated by semi-permeable layers, for example moisture-permeable layers, wherein three of the alternatingly successive stack plates each form two of the flow channels, which are formed such that flow is able to pass through them transversely to one another.

The proposed stack plate device may be suitable for humidifiers, for example for fuel cell systems. The fluid flow channels (exhaust gas and supply air channel) may be formed by means of two stack plates, which are stacked alternately with the first sides facing each other or with the second sides facing each other, and are used for the flow of moisture-laden exhaust gas, for example from a fuel cell, and dry supply air in the neighboring flow channel. The supply air may be humidified by moisture from the exhaust gas through the semi-permeable layer.

The semi-permeable layer of the stack plate thus separates the exhaust gas flow channel from the supply air flow channel. The semi-permeable layer can be designed, for example, as a PFSA (perfluorosulfonic acid) membrane. Such membranes are also commonly used as proton exchange membranes. The membrane is airtight but permeable to moisture. The semi-permeable layer may together with inlay parts, which support the semi-permeable layer, be over-molded as a frame of the stack plate. The stack plates are assembled by stacking the frames of the stack plates over each other. The frames of the stack plates may serve as stable seals.

According to an embodiment of the stack plate device, the stack plates may comprise a grid-like support element spanning the through-opening in the respective stack plate.

Separate grid-like support elements in the form of flow grids may be inserted between the stack plates. As a result, the fluid flow zigzags through the cross-rib structure of the flow grid. This targeted flow manipulation may achieve better mass transfer, for example better moisture transfer, from the moist exhaust gas to the dry supply air, thereby increasing the performance of the humidification system. The type of grille, in particular the height of struts forming the grille, the crossing angle of the struts, the spacing of the struts ("filament spacing") from one another, may be used to specifically influence the mass transfer and the pressure drop.

The grid on the exhaust side also serves as a spacer for the semi-permeable layers, which are designed as membranes, and prevents collapse of the flow channel due to a differential pressure between the exhaust gas and the supply air, which is forced into the associated flow channel at a higher pressure. The differential pressure between the supply air and the exhaust gas is usually in the range of about 300 mbar to about 600 mbar and even up to about 1 bar. Such a humidification device is suited for a fuel cell system.

The grid-like support element may be formed from plastic, for example PA6.6 (polyamide), PPA (polyphtalamide), PPS (polyphenylene sulfide), or TPX (polymethylpentene).

The grid-like support element may be arranged on the first side or on the second side of the stack plate. Alternatively, the grid-like support element may also be provided in both flow channels for the exhaust gas and the supply air flow. In this way, an even better mass transfer through the semi-permeable layer may be achieved. In addition, the semi-permeable layers are even better supported and held in position.

According to an embodiment of the stack plate device, the grid-like support elements on the first side of the stack plates may be formed differently from those on the second sides of the stack plates. For example, the grid-like support elements on the first sides may differ in height and/or thread spacing and/or crossing angle of struts in the support elements. In this way, an optimized mass transfer through the semi-permeable layer may be achieved.

According to an embodiment of the stack plate device, successive stack plates may be connected to one another in a fluid-tight manner except for inflow or outflow regions between the stack plates, for example be connected to one another at the frames of the stack plates. For example, successive stack plates may be bonded to one another. By this way, the flow channels may advantageously be sealed one against each other in the frame region in order to guarantee steady flow conditions for the exhaust gas and the supply air. Favorable humidity transfer through the semi-permeable layer may be provided.

According to an embodiment of the stack plate device, at least one receptacle for an axial or radial gasket may be arranged on an outer side of the stack plate device. For example, the frames of the successive stack plates may comprise incisions by means of which the receptacle is formed in the stacked stack plates. By means of such a seal, the stack plate device may be arranged in the housing of a humidifier in such a way that no bypass flow of the two fluid streams can occur around the plate stack. In this way, efficient humidification of the supply air may be achieved by transferring the moisture from the exhaust gas flow.

According to a further aspect of the invention, a humidifier for a fuel cell system is proposed, comprising a housing which has at least one inlet for a first fluid, in particular an exhaust gas of the fuel cell system, an inlet for a second fluid, in particular a supply air of the fuel cell system, an outlet for the first fluid and an outlet for the second fluid. The humidifier further comprises a stack plate device, in which a plurality of stack plates is arranged, the stack plates being stacked one atop of each other alternately in a stacking direction, with first sides of adjacent stack plates facing first sides and second sides of adjacent stack plates facing second sides. Three each of the alternately successive stack plates form a first and a second group of flow channels formed transversely to each other for flow of the first or second fluid therethrough. The first group of flow channels are arranged between the inlet and the outlet for the first fluid and the second group of flow channels are arranged between the inlet and the outlet for the second fluid.

The humidifier represents an embodiment of a flat membrane humidifier. A first moist or water-rich fluid, for example exhaust gas from fuel cells, flows in one group of flow channels, while a second, dry fluid, for example supply air for the fuel cells, flows in another group of flow channels. The second, dry fluid can be moistened by the first fluid via the semi-permeable membranes.

The stack plate device with the stack plates may, for example, be axially floatingly sealed in the housing via two axially acting seals located respectively at the ends on the inlet side and outlet side of the first or second fluid. These seals may seal either the supply air area or the exhaust gas area. In this manner, the exhaust gas area is sealed.

The housing of the humidifier may be made of metal, for example aluminum. Alternatively, it is also possible that the housing is made of plastics, for example PPS, PPA (polyphtalamide), PA (polyamide).

The housing may be made in several parts with a removable cover. In this way, the stack plate device may be removed from the housing for maintenance purposes and/or be replaced.

### BRIEF DESCRIPTION OF THE DRAWINGS

The present invention together with the above-mentioned and other objects and advantages may best be understood from the following detailed description of embodiments but not restricted to the embodiments.

FIG. 1 shows two inlay stripes as inlay parts for a stack plate according to an embodiment of the invention, in an isometric view.

FIG. 2 shows the inlay parts according to FIG. 1 with a semi-permeable layer on top.

FIG. 3 shows a stack plate for a stack plate device of a humidifier, for example a humidifier for a fuel cell system, according to an embodiment of the invention with a frame made by over-molding, in an isometric view.

FIG. 4 shows a cut view through the stack plate according to FIG. 3.

FIG. 5 shows the stack plate according to FIG. 3 from a first side with a flow direction of a second fluid.

FIG. 6 shows the stack plate according to FIG. 3 from a second side with a flow direction of a first fluid.

FIG. 7 shows the stack plate according to FIG. 3 from the first side with a grid-like support element placed on the plate.

FIG. 8 shows the stack plate according to FIG. 3 from the second side with a grid-like support element placed on the plate.

FIG. 9 shows three alternately stacked successive stack plates forming flow channels for the first and second fluid.

FIG. 10 shows a cut view through the three alternatingly successive stack plates forming flow channels for the first and second fluid of FIG. 9.

FIG. 11 shows two longitudinal inlay stripes as inlay parts for a stack plate according to a further embodiment of the invention, in an isometric view.

FIG. 12 shows a semi-permeable layer stacked between two short inlay stripes and two longitudinal inlay stripes.

FIG. 13 shows a stack plate according to a further embodiment of the invention, with the semi-permeable layer stacked between two short inlay stripes and two longitudinal inlay stripes, in an isometric view.

FIG. 14 shows a cut view through the stack plate according to FIG. 13.

FIG. 15 shows the stack plate according to FIG. 13 from a first side with a flow direction of a second fluid.

FIG. 16 shows the stack plate according to FIG. 13 from a second side with a flow direction of a first fluid.

FIG. 17 shows a semi-permeable layer in an isometric view.

FIG. 18 shows a plate as an inlay part according to a further embodiment of the invention, in an isometric view.

FIG. 19 shows a stack plate according to a further embodiment of the invention, with the plate as an inlay part, in an isometric view.

FIG. 20 shows a cut view through two alternately stacked stack plates according to FIG. 19.

FIG. 21 shows a stack plate device for a humidifier, for example for a fuel cell system, according to an embodiment of the invention during assembly, in an isometric view.

FIG. 22 shows a stack plate device according to an embodiment of the invention, in an isometric view.

FIG. 23 shows a humidifier for a fuel cell system according to an embodiment of the invention, in an isometric view.

### DETAILED DESCRIPTION

In the drawings, like elements are referred to with the same or similar reference numerals. The drawings are merely schematic representations, not intended to portray specific parameters of the invention. Moreover, the drawings are intended to depict only typical embodiments of the invention and therefore should not be considered as limiting the scope of the invention.

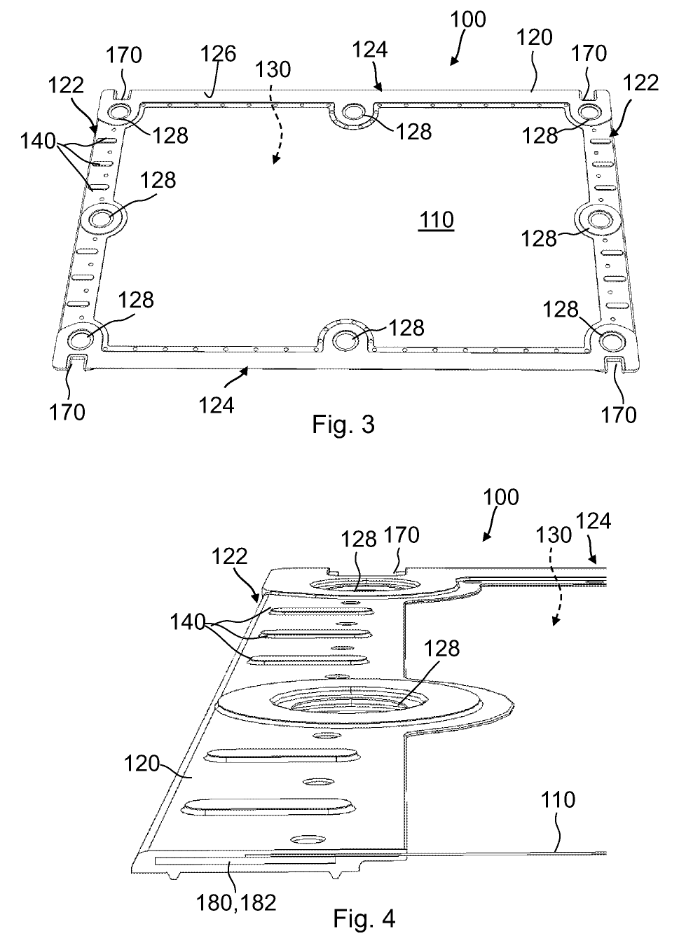

The proposed stack plate 100 for a stack plate device 400 of a humidifier 1000, for example a humidifier 1000 for a fuel cell system, comprises a circumferential frame 120 which encloses a through-opening 130. Such a stack plate 100 according to an embodiment of the invention is depicted in FIG. 3.

A semi-permeable layer 110 completely covers the through-opening 130. The through-opening 130 is a single hole in the stack plate 100. The semi-permeable layer 110 is supported by at least one inlay part 180 at least at two opposing front ends 114 and/or at two opposing longitudinal ends 116.

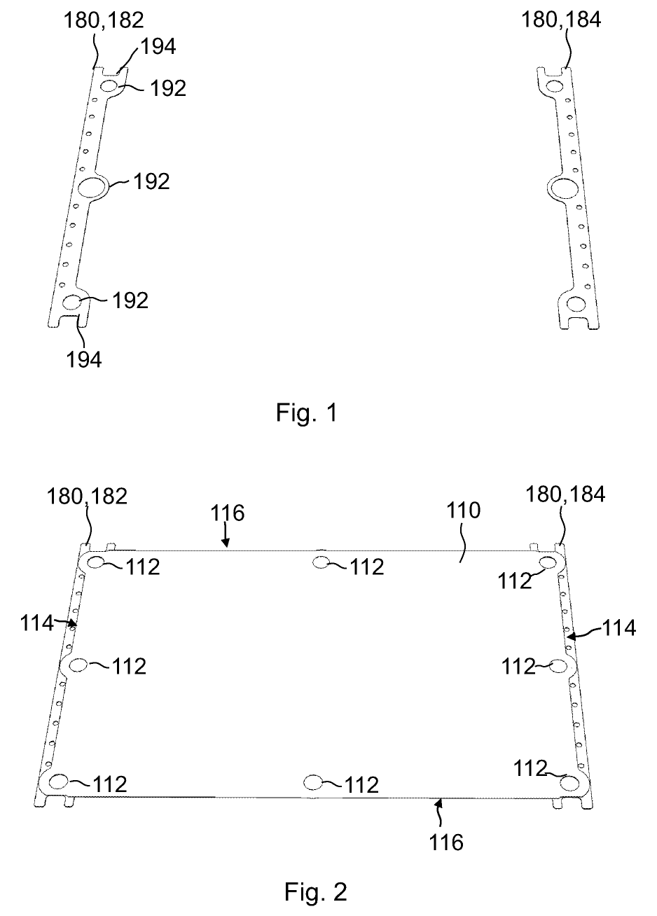

FIG. 1 depicts two inlay stripes 182, 184 as inlay parts 180 for the stack plate 100, whereas in FIG. 2 the inlay parts 180 according to FIG. 1 with a semi-permeable layer 110 on top are shown. The inlay stripes 182, 184 are provided with holes 192 and incisions 194 for a final assembly in a stack plate device 400. The semi-permeable layer 110, which is shown in FIG. 2 on top of the inlay stripes 182, 184, also is provided with holes 112 being congruent with the holes 192 of the inlay stripes 182, 184.

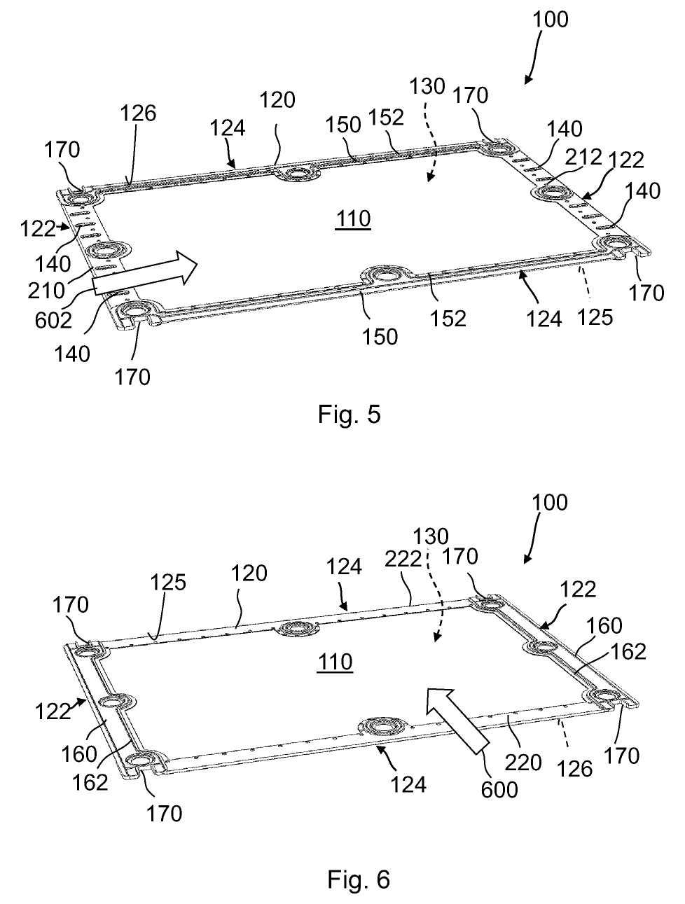

As shown with the stack plate 100 in FIG. 3, an outer circumference of the semi-permeable layer 110 together with the at least one inlay part 180 are embedded in the frame 120. Opposing front ends 122 of the frame 120 define inflow and outflow regions 210, 212, respectively, on a first side 126 of the frame 120 for a second fluid 602 (FIG. 5) and opposing longitudinal ends 124 of the frame 120 define inflow and outflow regions 220, 222, respectively, on a second side 125 of the frame 120 for a first fluid 600 (FIG. 6).

The frame 120 comprises an over-molded portion of the outer circumference of the semi-permeable layer 110 together with the inlay parts 180. Holes 128 and incisions 170 for assembly of the stack plate 100 in a stack plate device 400 are provided in the over-molded portion.

The two inlay stripes 182, 184 may be integrated into the frame 120 at the front ends 122 of the frame 120, as depicted in the embodiment shown in FIG. 2, or at the longitudinal ends 124 of the frame 120. For example, the two inlay stripes 182, 184 may be over-molded at the front ends 122 of the frame 120 or at the longitudinal ends 124 of the frame 120.

In FIG. 4 a cut view through the stack plate 100 according to FIG. 3 is depicted. In the cut view the inlay stripe 182 supporting the semi-permeable layer 110 is shown embedded in the over-molded portion of the frame 120. Also flow guiding elements 140, for the flow of the second fluid 602, as shown in FIG. 5, are formed in the over-molded portion of the frame 120.

FIG. 5 depicts the stack plate 100 according to FIG. 3 from a first side 126, the top side, with a flow direction of a second fluid 602.

Along the first side 126 of the stack plate 100, the second fluid 602, e.g. the supply air, enters the stack plate 100 through the inflow region 210 at the front end 122, traverses the semi-permeable layer 110 over the through-opening 130 in the stack plate 100 and leaves the stack plate 100 via the outflow region 212 at the opposing front end 122.

Flow guiding elements 140 for the second fluid 602 are arranged at the inflow and/or outflow regions 210, 212 of the frame 120.

The longitudinal ends 124 of the frame 120 have a first connecting region 150 on the first side 126 of the frame 120, with a first sealing 152, for being connected to the first side 126 of the frame 120 of a stack plate 100 adjacent in the stack plate device 400 when being alternatingly stacked for intended use. The first sealing 152 may be integral with the over-molded frame 120.

In FIG. 6 the stack plate is depicted from a second side 125, the bottom side, with a flow direction of a first fluid 600.

At the second side 125 of the stack plate 100, the first fluid 600, e.g. the exhaust gas, enters the stack plate 100 through the inflow region 220 at the longitudinal end 124, traverses the semi-permeable layer 110 over the through-opening 130 and leaves the stack plate 100 via the outflow region 222 at the opposing longitudinal end 124.

The front ends 122 of the frame 120 have second connecting region 160 on the second side 125 of the frame 120, with a second sealing 162, for being connected to the second side 125 of the frame 120 of a stack plate 100 adjacent in the stack plate device 400 when being alternatingly stacked for intended use. The second sealing 162 may be integral with the over-molded frame 120.

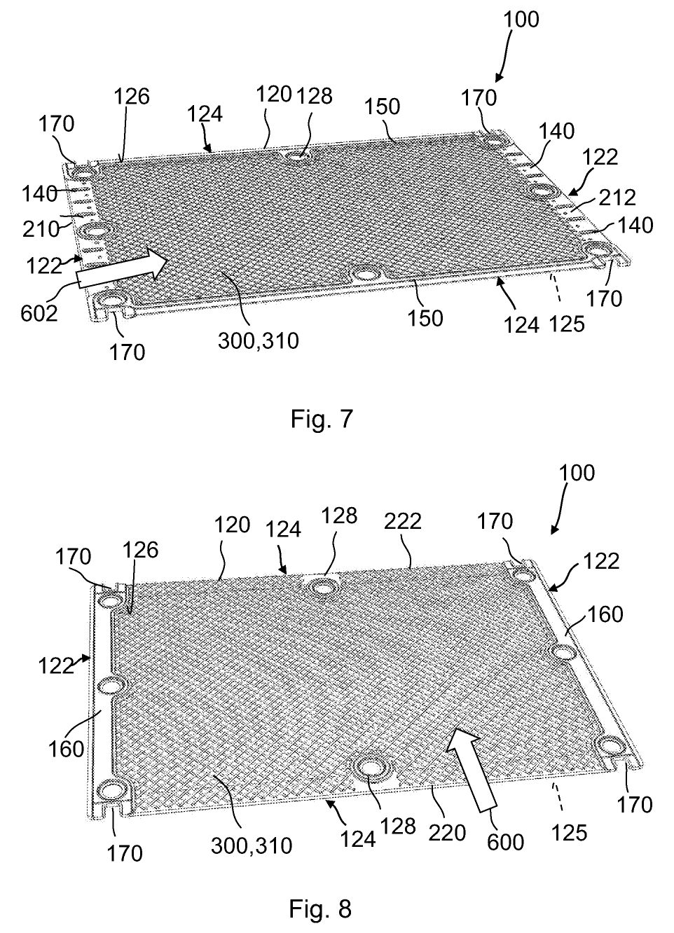

FIG. 7 depicts the stack plate 100 according to FIG. 3 from the first side 126 with a grid-like support element 300 placed on the semi-permeable layer 110 on the first side 126, whereas in FIG. 8 the stack plate 100 is shown from the second side 125 with an overlaid grid-like support element 300 placed on the semi-permeable layer 110 on the second side 125.

The grid-like support elements 300 with struts or ribs 310 may be arranged on the stack plate 100 to support the semi-permeable layer 110, and to also regulate the fluid flow for optimized mass transfer of the moisture from the exhaust gas flow. Height, angle and spacing of the struts can be varied. The grid-like support element 300 can be attached to the frame 120 of the stack plate 100 in a shape adapted to the frame 120, for example with recesses where mounting holes 128 are arranged in the stack plate 100.

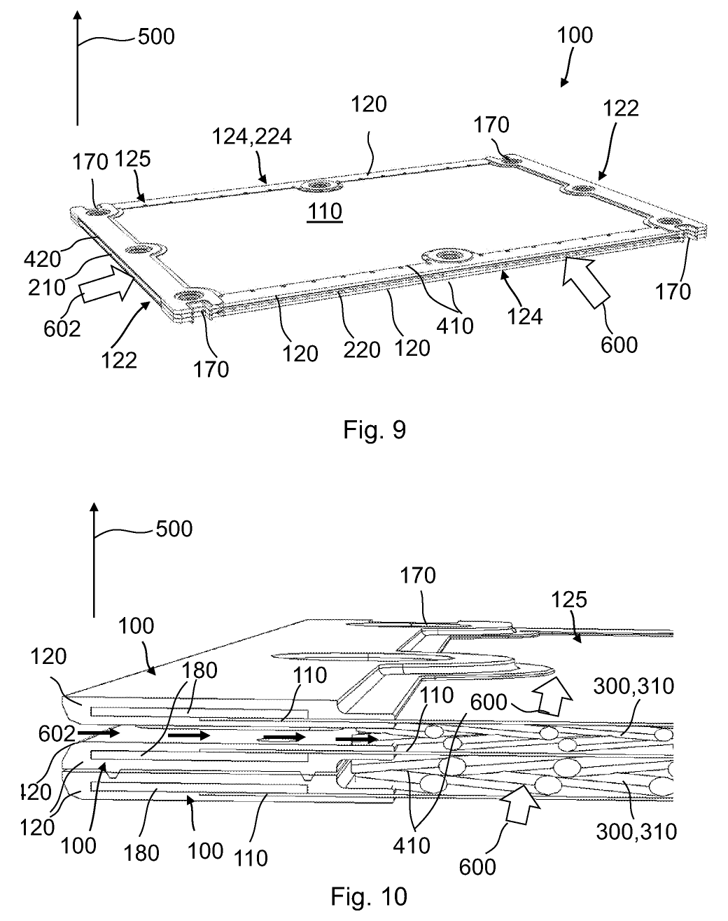

FIG. 9 depicts an arrangement comprising three successive stack plates 100 forming flow channels 410, 420 for the first fluid 600 and the second fluid 602, respectively. FIG. 10 depicts a cut view through the three alternatingly successive stack plates 100.

As is shown in the cut view of FIG. 10, the medium stack plate 100 is positioned with the first side 126 in the stacking direction 500 as depicted in the previous figures. The upper stack plate 100 and the lower stack plate 100 are positioned upside down with their second sides 125 at the outside of the arrangement of the three successive stack plates 100. This may be distinguished from the position of the semi-permeable layer 110 relative to the inlay part 180 of the frame 120.

The flow channel 420 with the second fluid 602, e.g., the supply air, is directed from left to right, indicated by the black arrows pointing from left to right in FIG. 10, between the upper most stack plate 100 and the medium stack plate 100.

The flow channels 410 with the first fluid 600, e.g., the exhaust gas, are directed into the picture plane, indicated by the arrows pointing from the front to the back in FIG. 10, above the upper most stack plate 100 and between the lowest stack plate 100 and the medium stack plate 100.

In the flow channels 410, 420 grid-like elements 300 are positioned to influence the fluid flow for better moisture transfer as well as to support the semi-permeable layer 110.

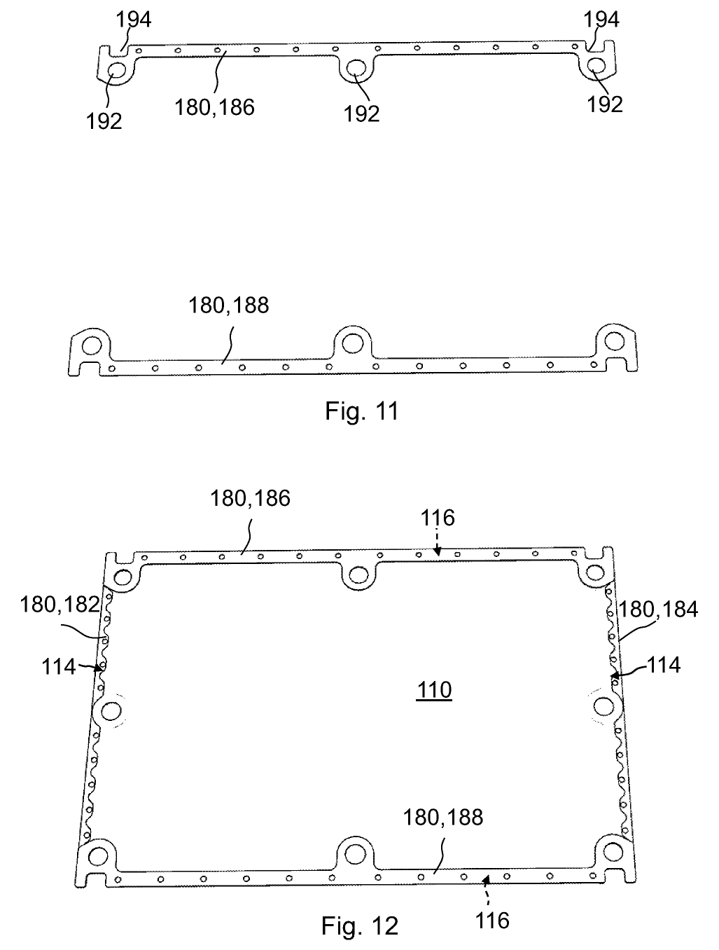

FIGS. 11-16 depict a further embodiment of the stack plate 100.

FIG. 11 depicts two longitudinal inlay stripes 186, 188 as inlay parts 180 for a stack plate 100 according to the further embodiment of the invention, in isometric view. In FIG. 12 a semi-permeable layer 110 is then stacked between two short inlay stripes 182, 184 and two longitudinal inlay stripes 186, 188.

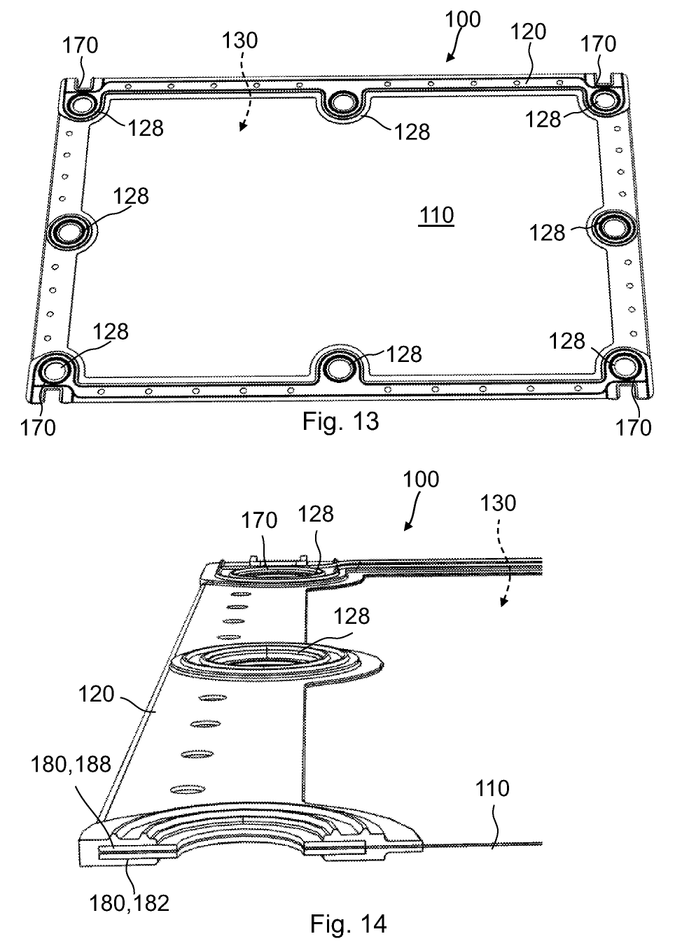

FIG. 13 depicts a stack plate 100 according to the further embodiment of the invention, with the semi-permeable layer 110 stacked between two short inlay stripes 182, 184 and two longitudinal inlay stripes 186, 188, in isometric view.

The inlay parts 180 for the embodiment shown comprise two first inlay stripes 182, 184 being integrated into the frame 120 at the front ends 122 of the frame 120 and two second inlay stripes 186, 188 at the longitudinal ends 124 of the frame 120. The semi-permeable layer 110 is inserted between the first two inlay stripes 182, 184 and the second two inlay stripes 186, 188. The outer circumference of the semi-permeable layer 110 together with the first two inlay stripes 182, 184 and the second two inlay stripes 186, 188 are then over-molded to form the frame 120.

Several mounting holes 128 for assembling the stack plate 100 are provided in the frame 120.

FIG. 14 depicts a cut view through the stack plate 100 according to FIG. 13. In the cut view of a corner of the frame 120 the overlay of the short inlay stripe 182, the semi-permeable layer 110 and the longitudinal inlay stripe 188 are shown.

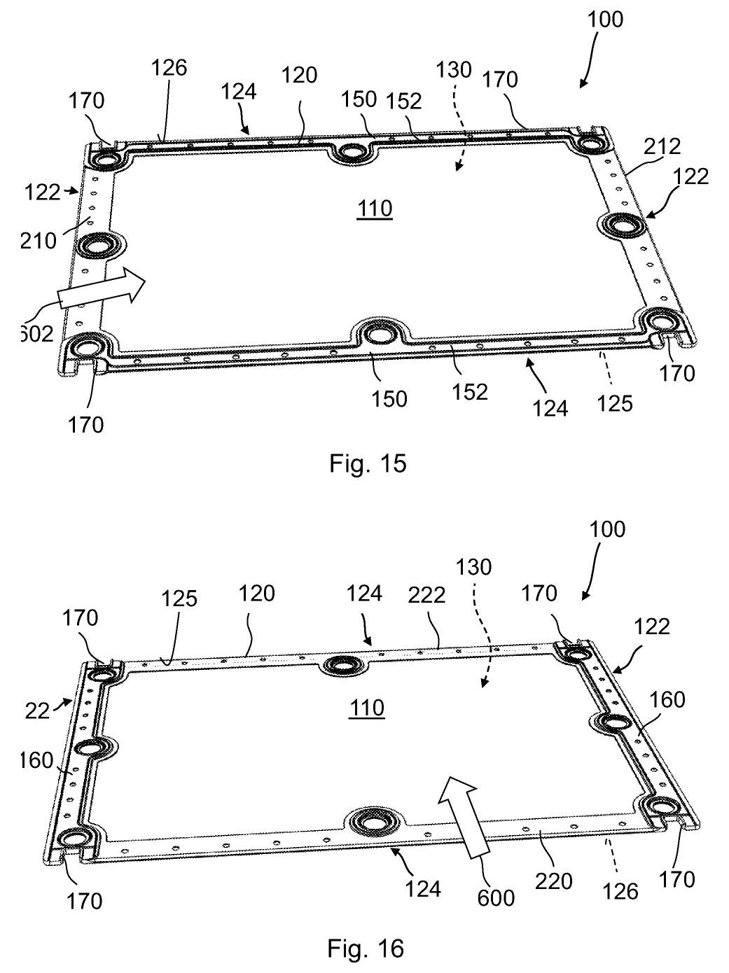

FIG. 15 depicts the stack plate 100 according to FIG. 13 from the first side 126 with a flow direction of a second fluid 602, whereas in FIG. 16 the stack plate 100 is depicted from the second side 125 with a flow direction of a first fluid 600.

The outer appearance and the functions of the stack plate 100 are quite the same as with the embodiment of the stack plate 100 shown in FIGS. 5 and 6, except that flow guide elements 140 are not provided on the inflow and outflow regions 210, 212. The difference, which is not shown, is that the stack plate 100 of FIGS. 15 and 16 exhibits additional stability of the frame 120 due to the longitudinal inlay stripes 186, 188 embedded in the frame 120.

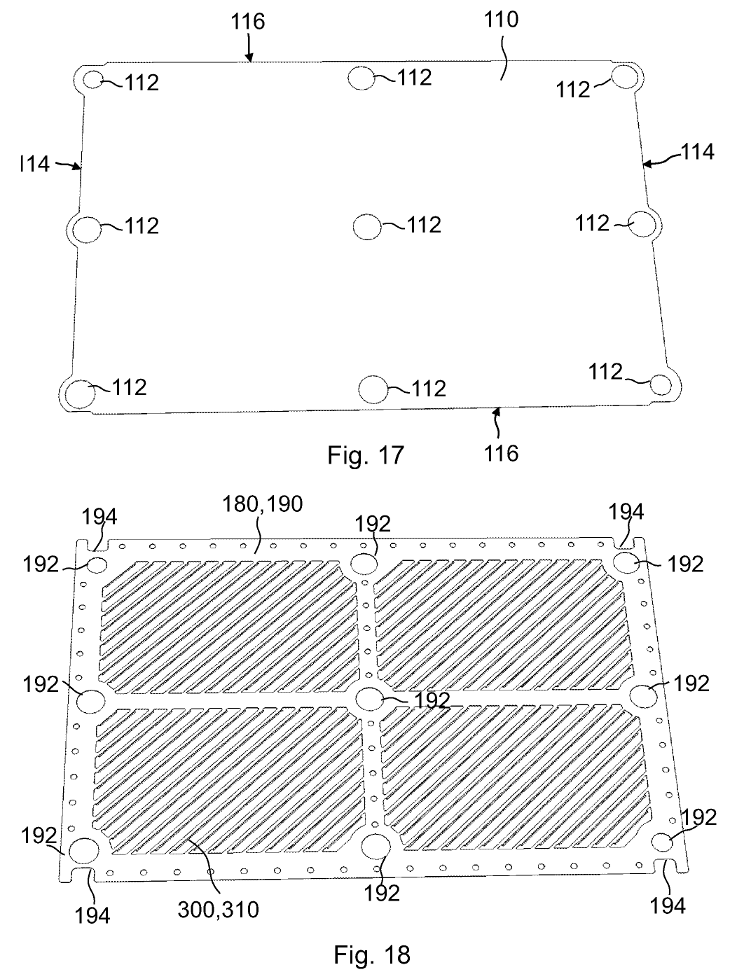

A further embodiment of a stack plate 100 is depicted in FIGS. 17-20.

In this embodiment, the at least one inlay part 180 comprises a plate 190 supporting the semi-permeable layer 110. The plate 190 may be configured as a grid-like support element 300.

FIG. 17 depicts the semi-permeable layer 110 with holes 112 for assembly in isometric view. FIG. 18 depicts the plate 190 as an inlay part 180, in isometric view.

The plate 190 may be configured with ribs 310, for example with L-shaped and/or U-shaped ribs 310, aligned in an oblique manner to a flow direction of the first fluid 600 and/or the second fluid 602. The plate 190 is also provided with holes 192 and incisions 194 for assembly in a stack plate device 400.

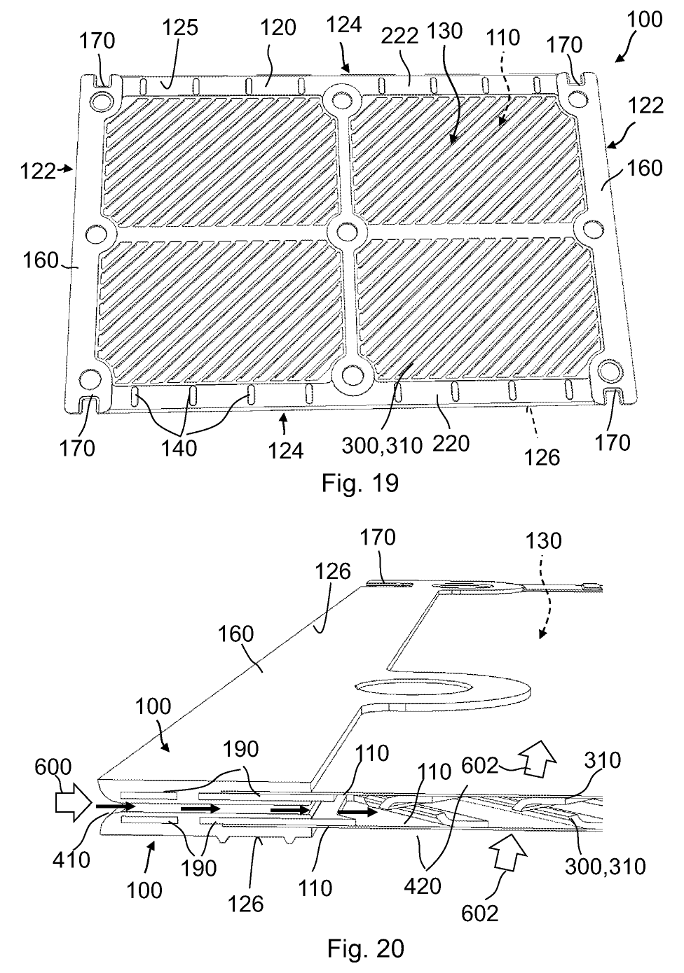

FIG. 19 depicts the stack plate 100 with the plate 190 as an inlay part 180, in isometric view. The stack plate 100 is shown from the second side 125. In this embodiment the inflow region 220 and outflow region 222 are provided with flow guiding elements 140 for a steady flow of the first fluid 600, e.g., the exhaust gas. The through-opening 130 in the stack plate 100 is a region with multiple breakthroughs.

In FIG. 20 a cut view through two alternatingly stacked stack plates 100 according to FIG. 19 is depicted.

The stack plates 100 are stacked with the second sides 125 joined together. So there is a flow channel 410 for the first fluid 600 between the stack plates 100 where the grid-like element 300 of the plate 190 may also influence the flow of the first fluid 600. The flow channel 420 for the second fluid 602, e.g., the supply air, is below the lower stack plate 100 and above the upper stack plate 100 perpendicular to the flow channel 410 of the first fluid 600.

As shown in the cut view, the ribs 310 of the grid-like element 300, are depicted as L-shaped and/or U-shaped ribs 310, aligned in an oblique manner to a flow direction of the first fluid 600.

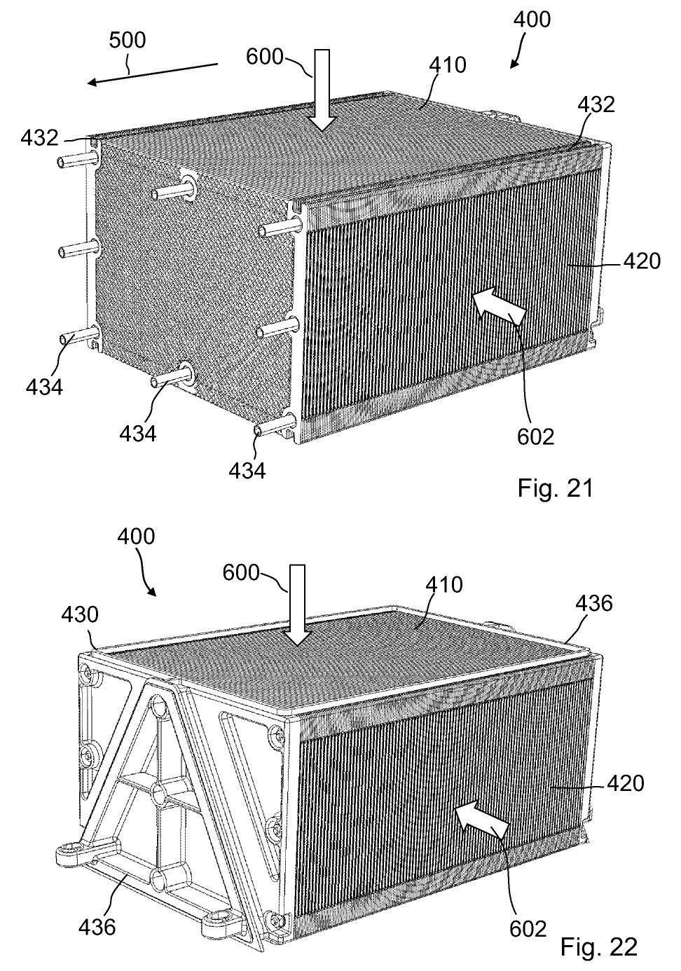

FIG. 21 depicts a stack plate device 400 for a humidifier 1000, for example for a fuel cell system, according to an embodiment of the invention during assembly, in isometric view, whereas in FIG. 22 the stack plate device 400 is depicted in the final assembled state.

The stack plate device 400 comprises a plurality of stack plates 100, which follow one another alternately in a stacking direction 500 with first sides 126 of adjacent stack plates 100 joined and second sides 125 of adjacent stack plates 100 joined. Each stack plate 100 comprises a peripheral frame 120 which encloses a through-opening 130.

At least first and second groups of flow channels 410, 420 are formed in the stack plate device 400, each having a flow direction transversely to one another and being separated by semi-permeable layers 110, for example moisture-permeable layers 110.

Three of the alternatingly successive stack plates 100 each form two of the flow channels 410, 420, which are formed such that flow can pass through them transversely to one another.

Successive stack plates 100 are connected to one another in a fluid-tight manner except for inflow or outflow regions 210, 212; 220, 222 of the flow channels 410, 420. For example, the successive stack plates 100 are connected to one another at the frames 120 of the stack plates 100. The successive stack plates 100 may be bonded to one another.

Receptacles 432 for an axial or radial gasket 430 are arranged on outer sides of the stack plate device 400. For example, the frames 120 of the successive stack plates 100 may have incisions 170 by means of which the receptacle 432 is formed.

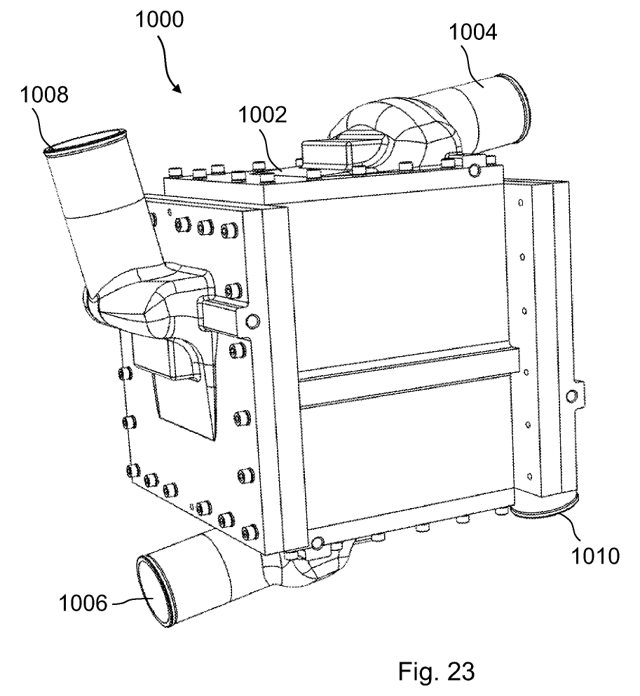

The gasket 430 may be used to seal the inlet region of the first fluid flow 600, i.e., the exhaust gas from the fuel cell, when the stack plate device 400 is installed in the housing 1002 of a humidifier 1000, as shown in FIG. 23. Bypass flow that would otherwise occur in the housing 1002 may thus be effectively prevented.

Tension anchors 434 are used for joining the stack plates 100 and keeping the stack plates 100 under a certain pressure for tight sealing the stack plates 100 against each other. The tension anchors 434 are fixed to end plates 436 of the stack plate device 400 on both ends.

In the embodiment of the stack plate device 400 shown, the first fluid 600, e.g., an exhaust gas, enters the stack plate device 400 through a first group of flow channels 410 from above and leaves the stack plate device 400 on the opposite side. The second fluid 602, e.g., supply air, enters the stack plate device 400 through a second group of flow channels 420 from a right side as depicted in the FIGS. 21 and 22 and leaves the stack plate device 400 on the opposite (left) side.

FIG. 23 shows a humidifier 1000 for a fuel cell system according to an embodiment of the invention, in isometric view.

The humidifier 1000 comprises a housing 1002 which has at least one inlet 1004 for a first fluid 600, for example an exhaust gas of the fuel cell system, an inlet 1008 for a second fluid 602, for example a supply air of the fuel cell system, an outlet 1006 for the first fluid 600 and an outlet 1010 for the second fluid 602. The humidifier 1000 further comprises a stack plate device 400, in which a plurality of stack plates 100 alternately following one another with first sides 126 of adjacent stack plates 100 joined and second sides 125 of adjacent stack plates 100 joined in a stacking direction 500 are arranged. Three each of the alternately successive stack plates 100 form a first and a second group of flow channels 410, 420 formed transversely to each other for flow of the first fluid 600 and/or the second fluid 602 therethrough, respectively. The first group of flow channels 410 are arranged between the inlet 1004 and the outlet 1006 for the first fluid 600 and the second group of flow channels 420 are arranged between the inlet 1008 and the outlet 1010 for the second fluid 602.

This which is claimed is:

1. A stack plate of a stack plate device of a humidifier, the stack plate comprising:
at least one inlay part;
a semi-permeable layer having an outer circumferential section supported by the at least one inlay part; and
a frame;
wherein the outer circumferential section of the semi-permeable layer and the at least one inlay part are embedded in an over-molded portion of the frame with the frame circumferentially enclosing a through-opening in the stack plate,
wherein a remaining portion of the semi-permeable layer covers the through-opening, and
wherein opposing front ends of the frame define inflow and outflow regions, respectively, on a first side of the frame for a second fluid, and opposing longitudinal ends of the frame define inflow and outflow regions, respectively, on a second side of the frame for a first fluid.

2. The stack plate of claim 1, wherein the opposing longitudinal ends of the frame comprise a first connecting region on the first side of the frame, the first connecting region being connectable to another first side of another frame of another stack plate adjacent to the stack plate in the stack plate device, and
wherein the opposing front ends of the frame comprise a second connecting region on the second side of the frame, the second connecting region being connectable to another second side of another frame of another stack plate adjacent to the stack plate in the stack plate device.

3. The stack plate of claim 1, wherein the frame comprises flow guiding elements disposed at the inflow and outflow regions on the first side of the frame for the second fluid.

4. The stack plate of claim 1, further comprising a grid-like support element disposed on each of the first side and the second side of the frame and spanning the through-opening in the stack plate.

5. The stack plate of claim 4, wherein the grid-like support element on the first side of the frame differs from the grid-like support element on the second side of the frame in at least one of height, thread spacing and a crossing angle of struts.

6. The stack plate of claim 1, wherein the at least one inlay part comprises:
two first inlay stripes extending along the two opposing front ends of the stack plate, respectively, and embedded within the over-molded portion of the frame at the opposing front ends of the frame; and
two second inlay stripes extending along the two opposing longitudinal ends of the stack plate, respectively, and embedded within the over-molded portion of the frame at the opposing longitudinal ends of the frame, and
wherein the semi-permeable layer is interposed between the two first inlay stripes and the two second inlay stripes.

7. The stack plate of claim 1, wherein the at least one inlay part comprises a grid-like plate extending along and supporting a surface of the semi-permeable layer.

8. The stack plate of claim 7, wherein the grid-like plate comprises ribs being aligned in an oblique manner to a flow direction of the first fluid and the second fluid.

9. The stack plate of claim 1, wherein the at least one inlay part is provided with at least one hole therethrough and the semi-permeable layer is provided with at least one hole therethrough that is congruent with a corresponding hole of the at least one inlay part.

10. The stack plate of claim 9, wherein the at least one hole of the at least one inlay part and the at least one hole of the semi-permeable layer are provided for assembling the stack plate device.

11. The stack plate of claim 1, wherein the frame is provided with at least one hole for assembling the stack plate in the stack plate device.

12. A stack plate device of a humidifier, the stack plate device comprising:
a plurality of stack plates stacked one atop of each other alternately in a stacking direction, first sides of adjacent ones of the plurality of stack plates facing each other, and second sides of adjacent ones of the plurality of stack plates facing each other; and
a first group of flow channels and a second group of flow channels for fluid flow transversely to one another through the plurality of stack plates, the first group of flow channels and the second group of flow channels being separated by a semi-permeable layer, and every three of the alternatingly successive stack plates forming two of the first group of flow channels and two of the second group of flow channels.

13. The stack plate device of claim 12, wherein successive ones of the plurality of stack plates are connected in a fluid-tight manner except at the inflow and outflow regions on the first sides and the second sides.

14. The stack plate device of claim 12, further comprising one or more receptacles for a gasket, the one or more receptacles being disposed on an outer side of the stack plate device and being incisions in a frame of each of the plurality of stack plates.

15. A humidifier comprising:
the stack plate device of claim 12; and
a housing comprising:
an inlet for the first fluid;
an inlet for the second fluid;
an outlet for the first fluid; and
an outlet for the second fluid,
wherein the first group of flow channels and the second group of flow channels are configured for flow of the first fluid and flow of the second fluid, respectively, therethrough,
wherein the first group of flow channels is arranged between the inlet for the first fluid and the outlet for the first fluid, and
wherein the second group of flow channels is arranged between the inlet for the second fluid and the outlet for the second fluid.
